(19) United States
(12) Patent Application Publication
(10) Pub. No.: US 2011/0250445 A1
(43) Pub. Date: Oct. 13, 2011

(54) MULTI-LAYER ADHESIVE INTERFACES

(75) Inventors: Andrew Alderson, Liverpool Merseyside (GB); Kim Alderson, Liverpool Merseyside (GB); Gleny Chirima, Bolton Hertfordshire (GB)

(73) Assignee: AUXETIC TECHNOLOGIES LIMITED, Buckinghamshire (GB)

(21) Appl. No.: 13/062,834

(22) PCT Filed: Sep. 11, 2009
(86) PCT No.: PCT/GB2009/051176

§ 371 Date: May 23, 2011

(30) Foreign Application Priority Data
Sep. 15, 2008 (GB) 0816829.6

(51) Int. Cl. B32B 7/12

(52) U.S. Cl. 428/343

(57) ABSTRACT

A multi-layer adhesive interface, comprising at least one film layer and at least one adhesive layer, each adhesive layer being adhered to at least one film layer, the film layers being impermeable to the adhesive of the adhesive layers, wherein at least one of the adhesive or film layers has a negative Poisson's ratio. The Poisson's ratio of the layers may vary through the interface and may vary from positive at one surface to negative at the other surface.

### BACKGROUND

This invention relates to material interfaces and in particular to multi-layer adhesive systems incorporating auxetic components.

Adhesives provide a convenient method of joining a first part to a second part. However, the adhesive joint may be a weak link in the overall construction and therefore limit the objects that can be constructed. This may be particularly evident where materials having differing mechanical properties must be joined. The differing properties may lead to the formation of stresses in the adhesive joint and thus to the failure of that joint.

FIG. 1 shows a double-sided adhesive in which two layers 10 of adhesive are provided on a substrate 11. The substrate 11 provides mechanical support for the adhesive layers and also allows the use of a different adhesive on each side. The interface structure thus allows different surfaces to be bonded where one adhesive is not suitable for use on both surfaces. An adhesive suitable for each surface is used on the appropriate side, and the material of the substrate layer is selected to be compatible with both adhesives.

The structure of FIG. 1 is still restricted in the combinations of surfaces that can be bonded and in the variability of the mechanical properties of the overall structure.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

There is provided a multi-layer adhesive interface, comprising at least one film layer and at least one adhesive layer, each adhesive layer being adhered to at least one film layer, the film layers being impermeable to the adhesive of the adhesive layers, wherein at least one of the adhesive or film layers has a negative Poisson's ratio.

At least one of the film layers may have a negative Poisson's ratio.

At least one of the adhesive layers may have a negative Poisson's ratio.

The Poisson's ratio of the layers may vary through the interface.

The Poisson's ratio of the film layers and/or the adhesive layers may vary through the interface.

The Poisson's ratio of the film layers may vary from a negative value for one outermost film layer to a positive value for the other outermost film layer.

The Poisson's ratio of the adhesive layers may vary from a negative value for one outermost adhesive layer to a positive value for the other outermost adhesive layer.

The outermost layer on one surface may be an adhesive layer.

The outermost layer on one surface may be a film layer.

The Young's modulus of the film layers may be higher or lower than the Young's modulus of the adhesive layers.

### DESCRIPTION OF THE DRAWINGS

Embodiments of the present invention will now be further described, by way of example, with reference to the drawings, wherein:—

FIG. 1 shows a cross-section of a double-sided adhesive structure;

FIG. 2 shows a multi-layer adhesive structure according to an embodiment of the current invention;

FIG. 3 shows a sandwich panel having an auxetic core;

FIG. 4 shows a selection of multi-layered interface structures according to the current invention;

FIG. 5 shows the improvement in tensile modulus for a selection of multi-layer interfaces according to embodiments of the current invention having a constant interface thickness and a low-modulus adhesive;

FIG. 6 shows the improvement in tensile modulus for the all-conventional and all-auxetic interfaces of FIG. 5;

FIG. 7 shows the change in tensile modulus for a selection of multi-layer interfaces according to embodiments of the current invention having a constant interface thickness and a high-modulus adhesive;

FIG. 8 shows the change in tensile modulus for the all-conventional and all-auxetic interfaces of FIG. 5;

FIG. 9 shows the deformation in tensile load for a selection of the interfaces of FIG. 5;

FIG. 10 shows the strain-energy distribution under tensile loads for a selection of the interfaces of FIG. 5;

FIG. 11 shows the improvement in shear modulus for a selection of multi-layer interfaces according to embodiments of the current invention having a constant interface thickness and a low-modulus adhesive;

FIG. 12 shows the change in shear modulus for the all-conventional and all-auxetic interfaces of FIG. 11;

FIG. 13 shows the change in shear modulus for a selection of multi-layer interfaces according to embodiments of the current invention having a constant interface thickness and a high-modulus adhesive;

FIG. 14 shows the change in shear modulus for the all-conventional and all-auxetic interfaces of FIG. 13;

FIG. 15 shows the deformation under a shear loading of a selection of interfaces of FIG. 11;

FIG. 16 shows a selection of multi-layered interfaces according to embodiments of the current invention;

FIG. 17 shows the improvement in tensile modulus for a selection of multi-layer interfaces according to embodiments of the current invention having a constant layer thickness and a low-modulus adhesive;

FIG. 18 shows the improvement in shear modulus for the all-conventional and all-auxetic interfaces of FIG. 17;

FIGS. 19 to 21 illustrate the parameters of a selection of gradient interfaces; and

FIGS. 22 and 23 show a comparison of Finite-Element and Rule-of-Mixtures models of multi-layer interfaces.

The following figures relate to Appendix 1.

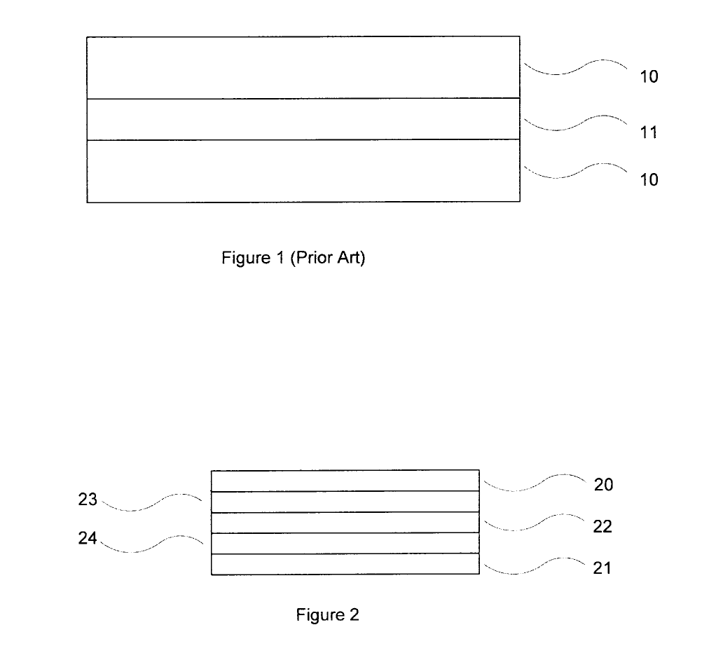

FIG. 1a shows a schematic of the extruder;

FIG. 2a shows a diagram of a marked film ready for testing with arrows indicating the testing direction;

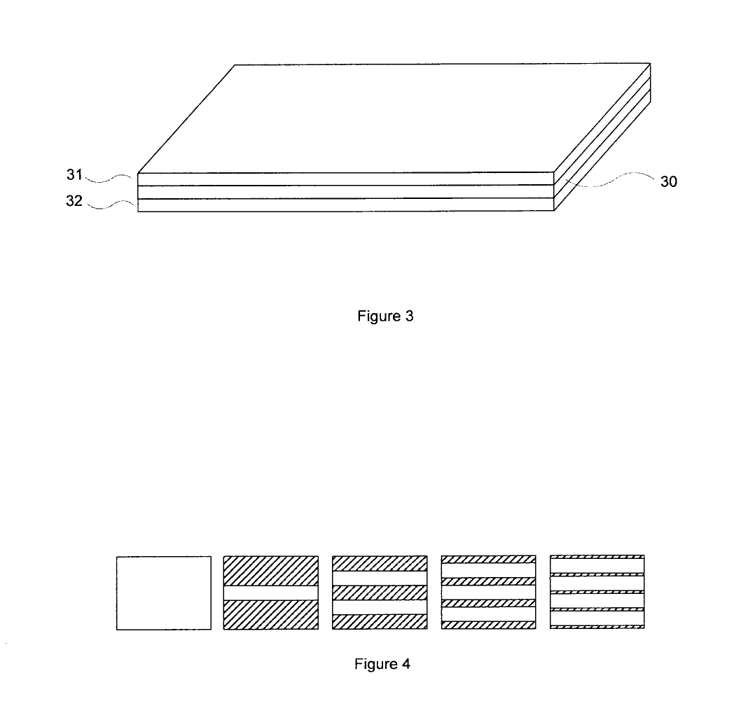

FIG. 3a shows a schematic of the videoextensometer set up;

FIG. 4a shows a graph of length/width versus time data from the videoextensometer for PP film produced at a temperature of 230° C., screw speed of 1.05 rads⁻¹ and take-up speed of 0.03 m s⁻¹. The length data are shown in bold;

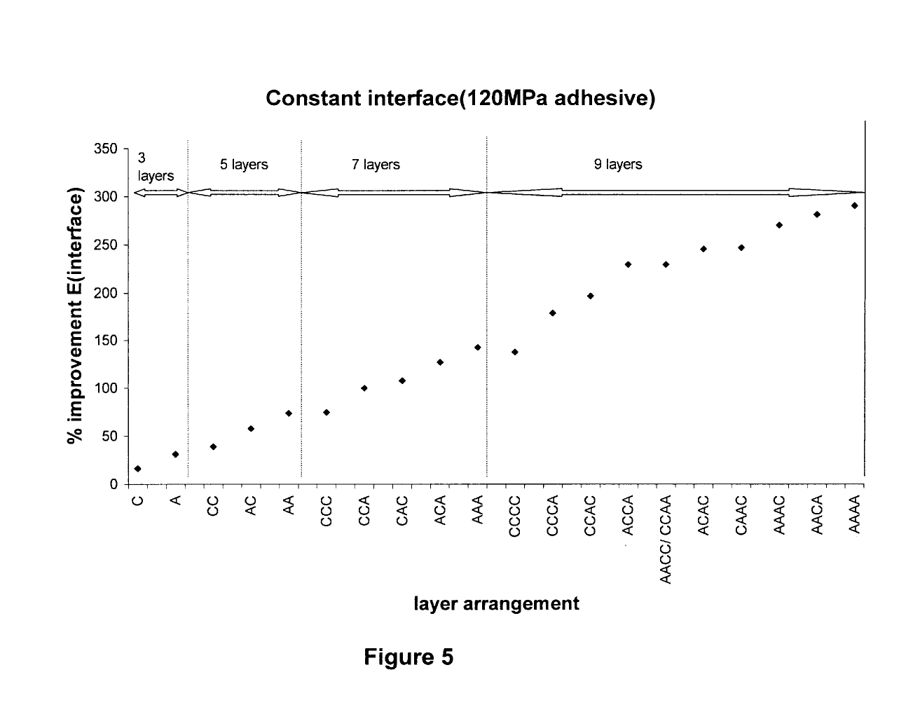

FIG. 5a shows a graph of the true strain in the y direction against the true strain in the x direction tested along the film extrusion direction for a film extruded at a temperature of 230° C., screw speed of 1.05 rads⁻¹ and take-up speed of 0.03 m s⁻¹;

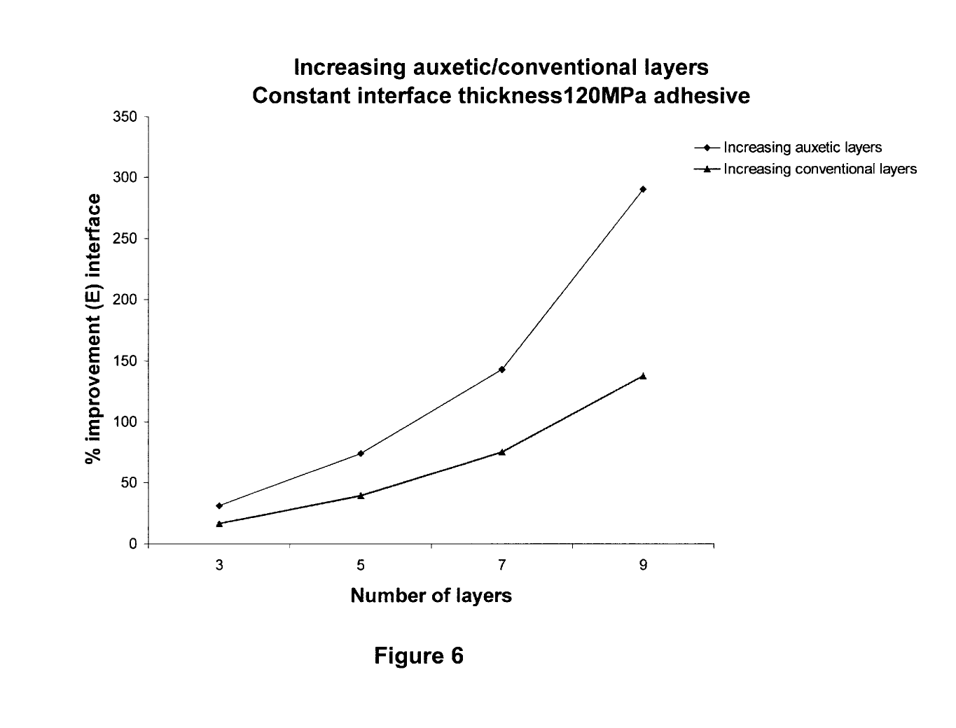

FIG. 6a shows a graph of stress against strain for a film extruded at a temperature of 230° C., screw speed of 1.05 rads⁻¹ and take-up speed of 0.03 m s⁻¹;

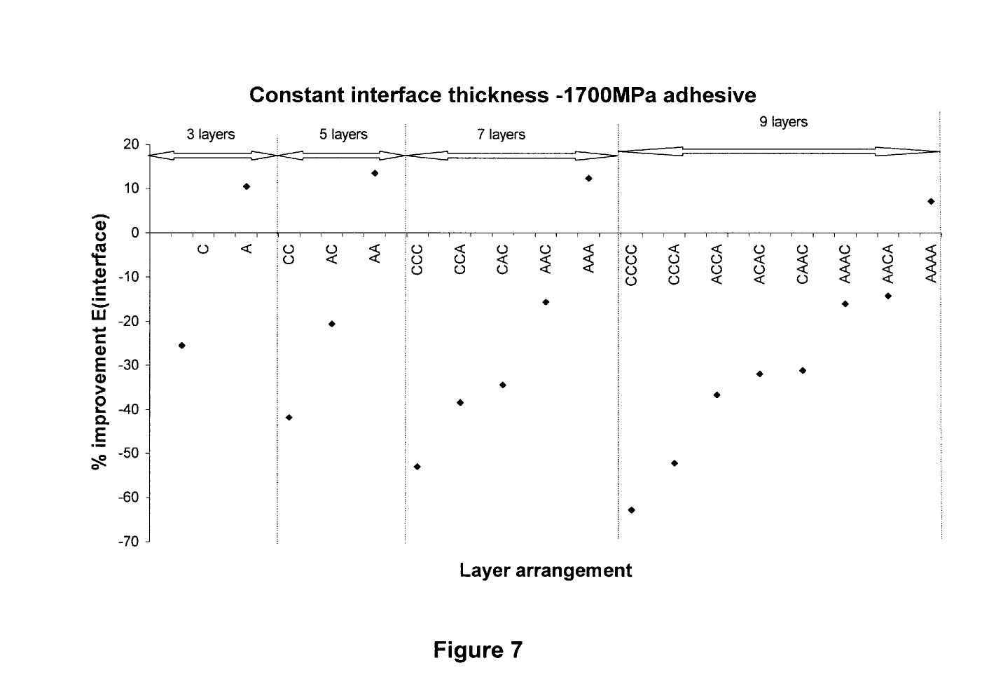

FIG. 7a shows a graph of length/width versus time data from the videoextensometer for PP film produced at a temperature of 159° C., screw speed of 1.05 rads⁻¹ and take-up speed of 0.03 m s⁻¹. The length data are shown in bold;

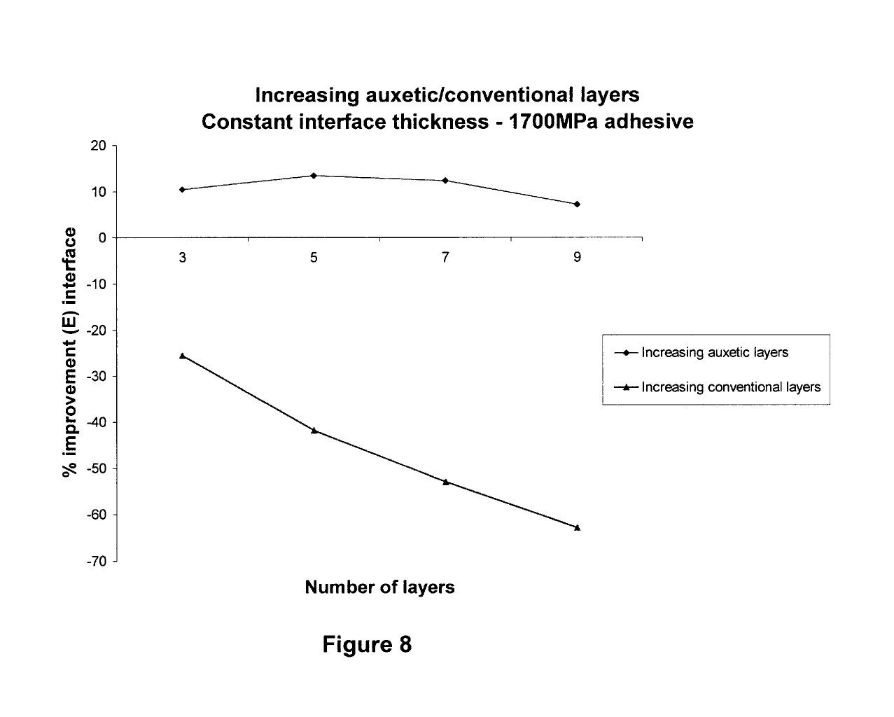

FIG. 8a shows a graph of the true strain in the y direction against the true strain in the x direction tested along the film extrusion direction for a film extruded at a temperature of 159° C., screw speed of 1.05 rads⁻¹ and take-up speed of 0.03 m s⁻¹;

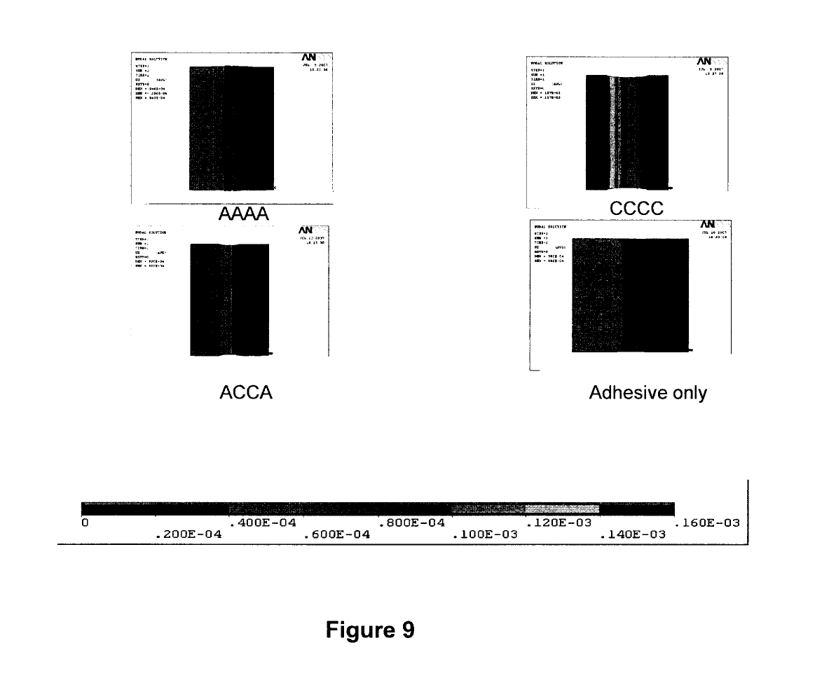

FIG. 9aa shows a graph of Poisson's ratio against temperature (° C.) for fibres extruded at a screw speed of 1.05 rad s⁻¹ and a take up speed of 0.0225 m s⁻¹;

FIG. 9ba shows a graph of modulus (GPa) against temperature (° C.) for fibres extruded at a screw speed of 1.05 rad s⁻¹ and a take up speed of 0.0225 m s⁻¹;

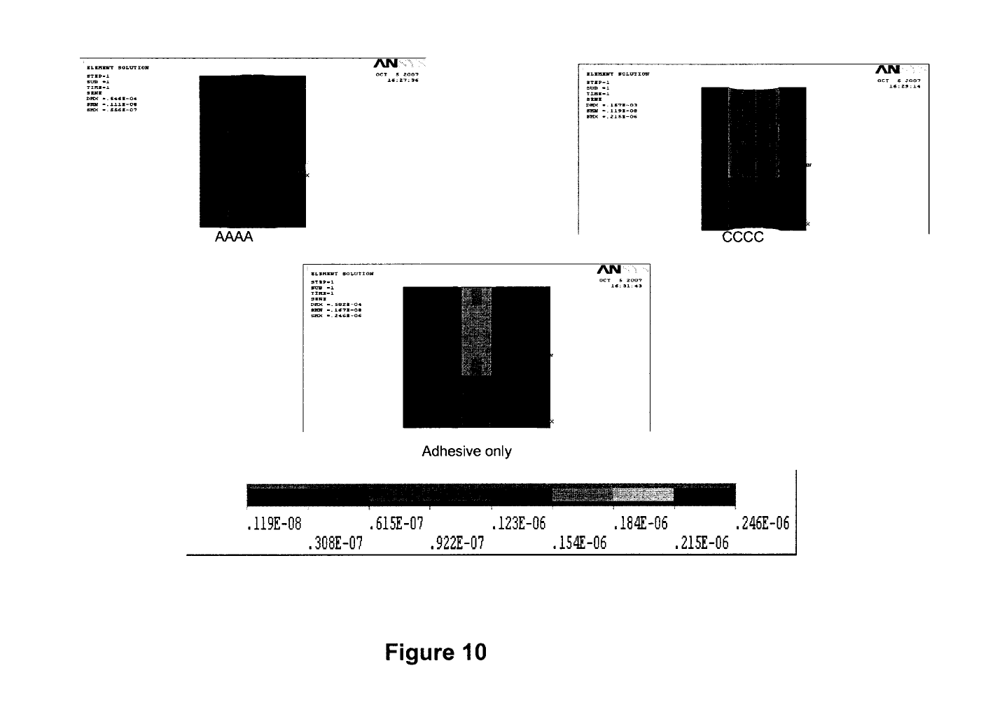

FIG. 10a shows a graph of Poisson's ratio against screw speed (rad s⁻¹) for fibres extruded at a temperature of 159° C. and a take up speed of 0.0225 m s⁻¹;

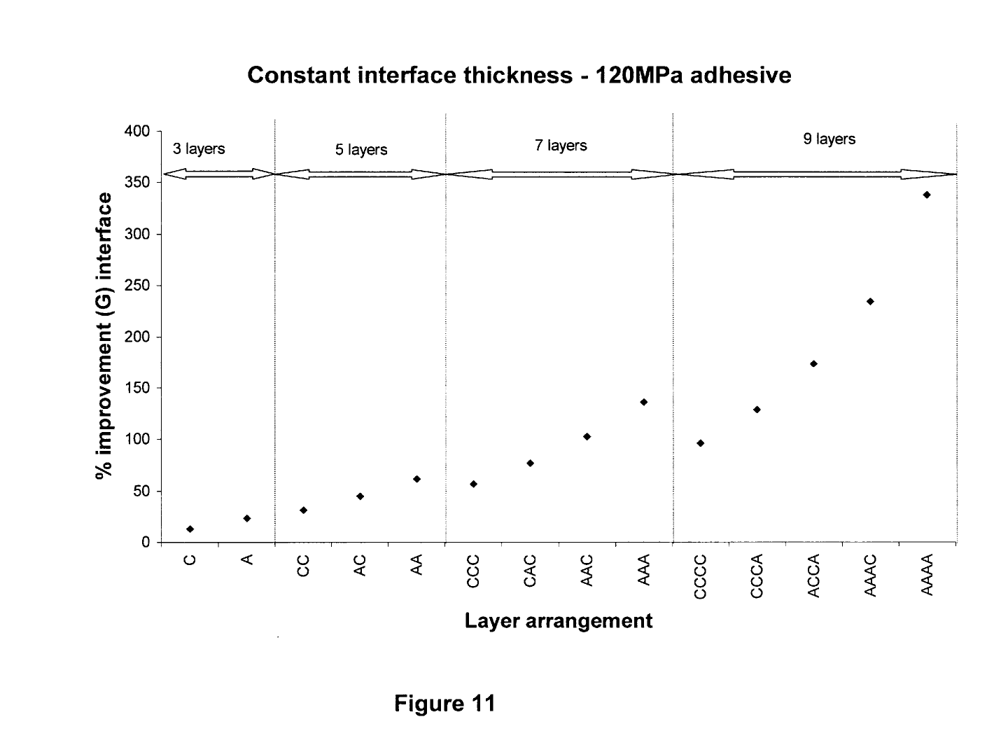

FIG. 11aa shows a graph of Poisson's ratio against take up speed (m s⁻¹) for fibres extruded at a screw speed of 1.05 rad s⁻¹ and a temperature of 159° C.;

FIG. 11ba shows a graph of modulus (GPa) against take up speed (m s⁻¹) for fibres extruded at a screw speed of 1.05 rad s⁻¹ and a temperature of 159° C.;

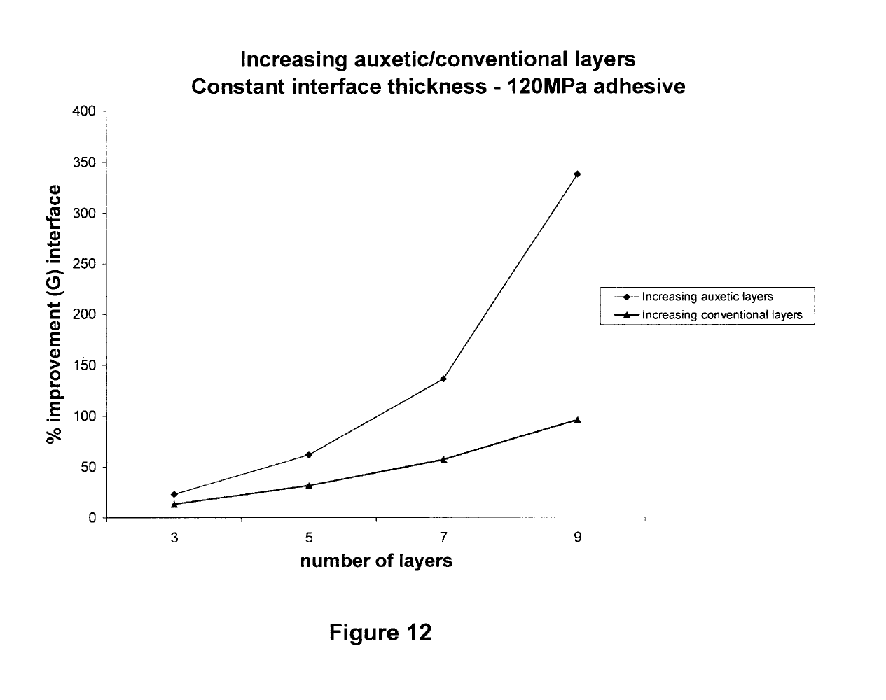

FIG. 12aa shows a graph of Poisson's ratio against take up speed (m s⁻¹) for fibres extruded at a screw speed of 2.10 rad s⁻¹ and a temperature of 180° C.;

FIG. 12ba shows a graph of modulus (GPa) against take up speed (m s⁻¹) for fibres extruded at a screw speed of 2.10 rad s⁻¹ and a temperature of 180° C.; and

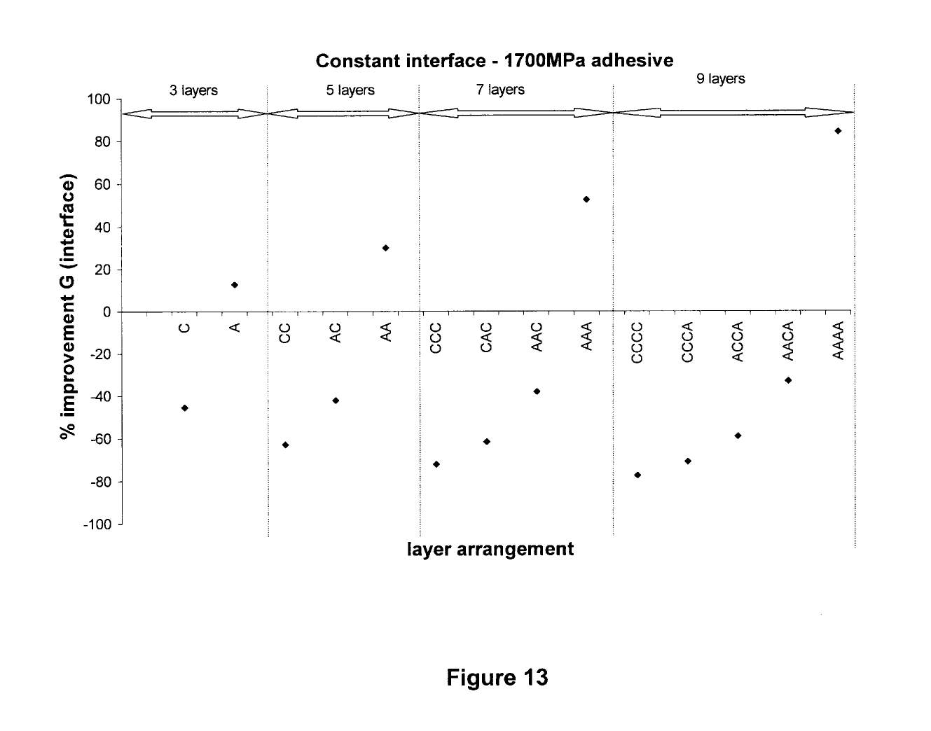

FIG. 13a shows a micrograph of an auxetic fibre showing the fused particle microstructure [17].

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In order to improve the performance of adhesives, particularly in relation to adhesives for joining incompatible surfaces, the current invention provides a multi-layer adhesive structure. The adhesive structure may include film and/or adhesive layers having auxetic properties to further improve the performance. FIG. 2 shows a cross-section of an adhesive structure according to an embodiment of the invention. Outer adhesive layers 20, 21 are provided to bond to the objects being joined. A further adhesive layer 22 is provided between two substrate layers 23, 24. Each of the layers may be formed of different materials and/or have different mechanical properties.

In an embodiment of the invention the material of the layers, and/or the mechanical properties, varies through the structure. By varying the structure's mechanical properties through its thickness an interface between mechanically mis-matched materials can be provided. When mismatched materials are joined using conventional adhesives, stresses can form in the adhesive layer due to the mismatch, leading to failure of the joint. By providing a gradient interface the change in properties at any point is minimised, thereby reducing stress-build up and hence improving the performance of the joint.

FIG. 3 shows a sandwich panel having an auxetic honeycomb core 30 between conventional laminate skins 31, 32. An auxetic structure or material is one which has a negative Poisson's ratio and hence expands in a direction perpendicular to a direction of applied stress. Sandwich panels utilising an auxetic core may have an improved performance compared to panels with conventional cores (see, for example, Auxetic Materials, A. Alderson, K. AldersonProc. Inst. Mech. Eng., Part G, J. Aero. Eng., 221 (2007) 565), but their performance may be limited by the ability to bond the mismatch honeycomb and skin materials.

The skins 31, 32 may be a high-modulus, positive Poisson's ratio laminate, while the core 30 may be a low modulus, negative Poisson's ratio honeycomb. The use of conventional adhesives to bond the skins 31, 32 to the core 30 may result in stress build-up at the interface and hence a weakening of the joint and of the overall structure. The interface structure shown in FIG. 2, when provided with layers having an auxetic behaviour, provides a system to bond the skins 31, 32 to the core 30 with reduced stress build-up and hence improved performance.

Thin films with a negative Poisson's ratio have been manufactured in suitable materials and dimensions for the production of a multi-layer interface having auxetic layers as shown in FIG. 2. For example, see Auxetic Polypropylene Films N. Ravirala, A. Alderson, K. L. Alderson, P. J. Davies. Polymer Engineering and Science 45(4) (2005) 517. Appendix 1 at the end of this description comprises a paper reporting on the production of auxetic films and the control of their parameters. Films made according to the methods described therein may be suitable for use in interfaces according to the current invention. Appendix 1 forms a part of the description of this application.

In order to analyse the performance of the family of multi-layer structures including that shown in FIG. 2 simulations were conducted of various adhesive and interface systems, as set out below.

FIG. 4 shows a set of five interface structures, each of which has a total thickness of 1 mm. Hatched layers comprise adhesive layers and unfilled layers comprise film layers. The film layers are a constant 0.2 mm thick and thus the total adhesive thickness varies between structures. The adhesive-only interface forms a reference for comparison.

Each of the film layers may be either a conventional film or an auxetic film. Both types of film have a modulus of 340 MPa. The conventional film has an in-plane Poisson's ratio (ν) of 0.43, and the auxetic film has ν=−0.9. The adhesive has ν=0.33 and a modulus of 120 MPa. These values are representative of materials that may be utilised in these applications.

A Finite Element (FE) model was constructed for each of the interfaces and a tensile loading simulation run. FIG. 5 shows the improvement in the tensile modulus compared to the adhesive-only interface. The x-axis represents the number of layers and the type of films. ‘A’ represents an auxetic film and ‘C’ represents a conventional film. Moving to the right of the chart represents an increase in the total number of layers and an increase in the number of auxetic layers in a given structure.

All of the multi-layer interfaces show an improved modulus in comparison to the adhesive-only interface. Furthermore, the improvement increases as the number of auxetic layers increases for a given total number of layers.

FIG. 6 shows a chart of improvement in tensile modulus against the number of layers for structures using all-conventional and all-auxetic films. The improvement obtained with auxetic layers is seen to be higher than the improvement with conventional layers. An improvement of nearly 300% is noted for a 9-layer interface with 4 auxetic layers. It is thought that the improvement seen for the all-conventional cases is due to the higher modulus of the films compared to the adhesive. The additional enhancement for the systems including auxetic layers is thought to be due to the constraining effect of adjacent layers of material in the direction perpendicular to the direction of applied load. An auxetic film will try to expand in an in-plane direction when stretched in the perpendicular through-thickness direction, whereas the adjacent (positive Poisson's ratio) adhesive will try to contract in an in-plane direction under the same applied loading condition. The auxetic film, therefore, acts to apply an in-plane tensile load on the adjacent adhesive layer which leads to a positive Poisson's ratio-induced contraction of the adhesive layer in the perpendicular through-thickness direction. This contractile component of strain in the through-thickness direction opposes the directly applied tensile strain in this direction. Similarly, the adhesive layer in-plane contraction due to the direct tensile applied load in the through-thickness direction leads to a reduction in the overall tensile deformation of the auxetic layer in the through-thickness direction. Hence for any given applied stress, the strain of the individual layers in the loading direction is lower (corresponding to a higher Young's modulus) for the combined system including both negative and positive Poisson' ratio components than for a system including components having only one sign of Poisson's ratio.

A variation of the structures shown in FIG. 4 was simulated with a high modulus adhesive. A modulus of 1700 MPa was utilised, with all other properties being the same as previously. FIG. 7 shows a chart of modulus change against layer configuration for the high-modulus adhesive. For this system the addition of a conventional film always lowers the modulus of the interface, but the addition of an all-auxetic set of films improves the modulus of the interface. FIG. 8 shows a chart of the change in modulus for the all-conventional and all-auxetic cases.

FIG. 8 shows that the improvement in the all-auxetic cases decreases for 7 and 9 layers (3 and 4 film layers) compared to the 5 layer structure (2 film layers), which shows the biggest increase in modulus. This pattern is in contrast to the all-conventional structures in which the modulus consistently decreases as the number of layers increases. It is surprising that for the 9 layer all-auxetic system, in which the interface is 80% low-modulus material and 20% high-modulus adhesive, there is still an increase in modulus compared to the 100% high-modulus adhesive case. The contributions to the modulus of the all auxetic system comprise a decrease due to the addition of lower modulus film material and an increase due to the constraining effect of adjacent layers of negative Poisson's ratio film and positive Poisson's ratio adhesive referred to above. The constraining effect dominates the response due to the high mismatch in the Poisson's ratios of the two constituents, leading to the observed increase in the modulus of the overall interface. The reduction in the overall enhancement in modulus observed for the 3 and 4 film layer (7 and 9 total layer) systems is due to the relatively high content of lower modulus film material in these cases.

FIG. 9 shows the deformation in the Z-direction (horizontal) under a tensile load for various combinations of film types. Each interface has four film layers with the types noted below the respective chart. The materials are as noted above for the high-modulus adhesive cases. FIG. 9 confirms the all auxetic system undergoes the least amount of extension along the z direction consistent with this system having the enhanced Young's modulus shown in FIG. 8. The systems having some conventional film layers in FIG. 9 are seen to undergo more extension along the z-direction, consistent with having a lower effective Young's modulus than the adhesive-only system (FIG. 8). The expansion or contraction in the (vertical) direction perpendicular to the z-direction can be seen to vary dependent on the position of the auxetic films.

FIG. 10 shows strain energy plots corresponding to the results shown in FIG. 9. These plots show that the all-auxetic films show the least strain energy build-up and, therefore, demonstrate enhanced toughness for this interface with respect to the adhesive-only and all-conventional films interfaces.

The interfaces described in relation to FIG. 4, utilising an adhesive with a modulus of 120 MPa, were simulated under shear loading using a Finite Element (FE) model. FIG. 11 shows the improvement in shear modulus for the various interface configurations compared to an all-adhesive interface. The addition of film layers to the interface increased the shear modulus in all cases, but as summarised in FIG. 12, a greater improvement was seen with the use of auxetic layers rather than conventional layers. A greatest increase of nearly 350% was seen for the interface having four auxetic film layers.

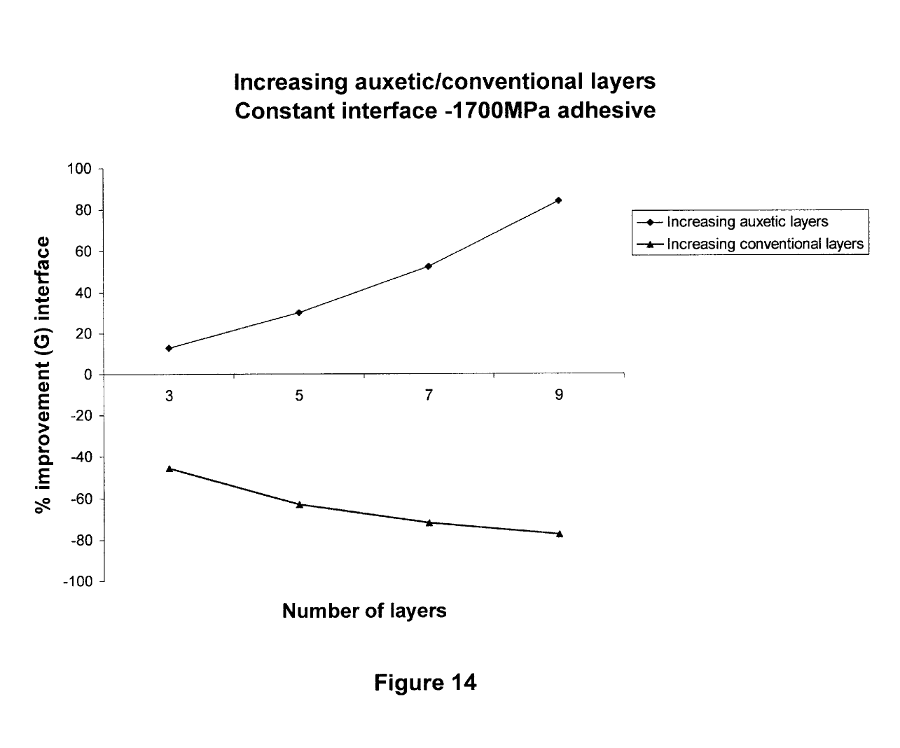

FIG. 13 shows the change in shear modulus in the systems described in relation to FIG. 4, but utilising an adhesive with a modulus of 1700 MPa. FIG. 14 summarises the results for the all-auxetic and all-conventional film cases. In these interfaces the addition of film layers decreases the shear modulus for all cases, apart from that in which only auxetic layers are utilised. An improvement of up to about 80% is seen with 4 auxetic film layers. It is noted that the decrease seen in the results presented in relation to FIG. 8 is not seen in the shear modulus.

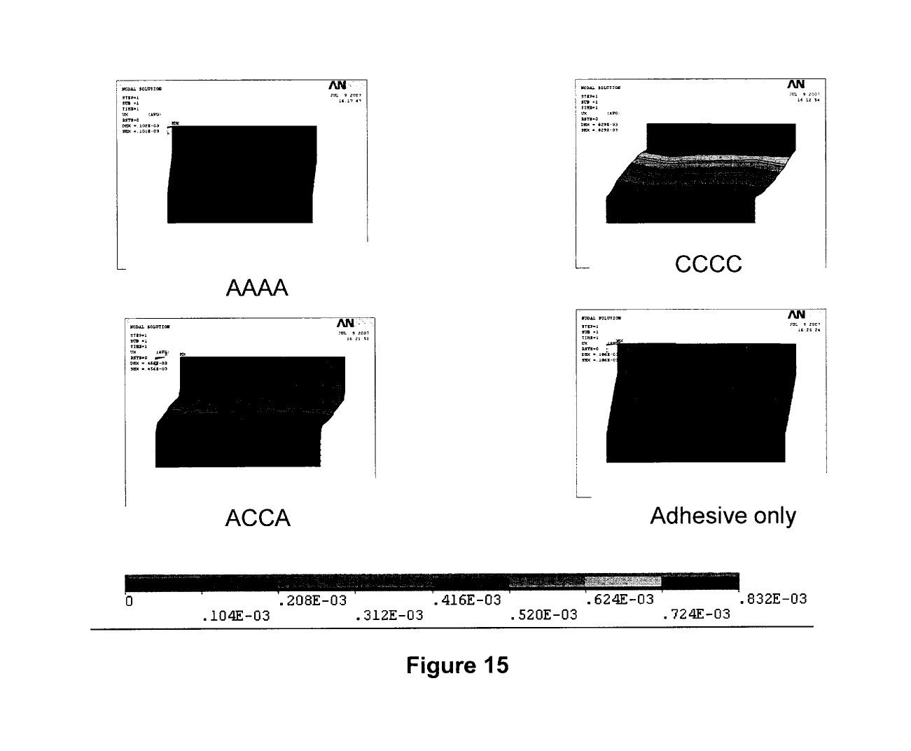

FIG. 15 shows deformation patterns for four of the structures described in relation to FIG. 4 under shear loading utilising an adhesive with a modulus of 1700 MPa. The minimum deformation is seen in the all-auxetic case, with the maximum deformation being in the all-conventional case, consistent with the enhanced and reduced shear rigidity in these systems, respectively (FIGS. 14 and 15).

From classical elasticity theory, it is well known that the shear modulus, G, of an isotropic material is related to the Young's modulus (E) and Poisson's ratio ( ) of the material by

G=E/2(1+ν)

For isotropic materials the thermodynamically allowed range of Poisson's ratio values is −1<<+0.5. For any given value of E, the shear modulus will assume very large values as ν approaches the negative limit of −1. On the other hand, the shear modulus decreases as approaches the positive limit of +0.5. This explains why the all-auxetic film interface demonstrates enhanced shear rigidity since a greater proportion of shear resistant material is introduced in this case. Conversely, the all-conventional film interface contains the greatest proportion of shear compliant material leading to the decrease in shear rigidity of the interface as the number of layers is increased.

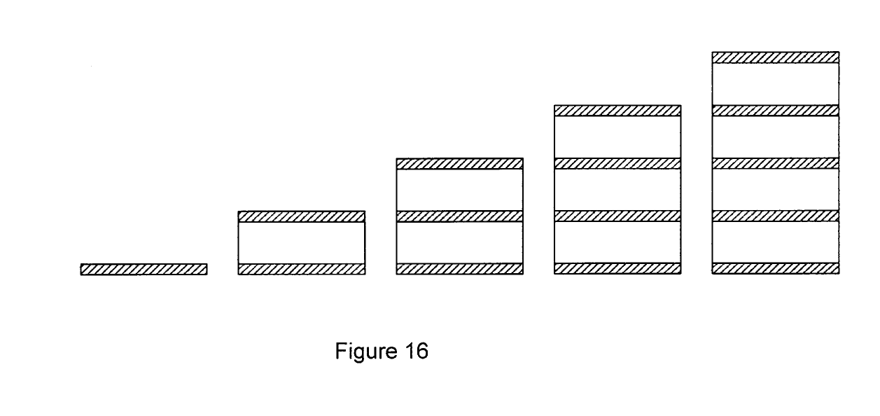

FIG. 16 shows schematic diagrams of a second set of layered interface structures. The patterns of layers in these structures is the same as those described previously, but the individual layer thickness is constant and thus the overall interface thickness increases as the number of layers increases. The adhesive layer thickness is 0.05 mm and the film thickness is 0.2 mm. The modulus of both the conventional and auxetic films was 340 MPa. The Poisson's ratio of the conventional film was 0.43 and of the auxetic film was −0.9. The Poisson's ratio of the adhesive was 0.33.

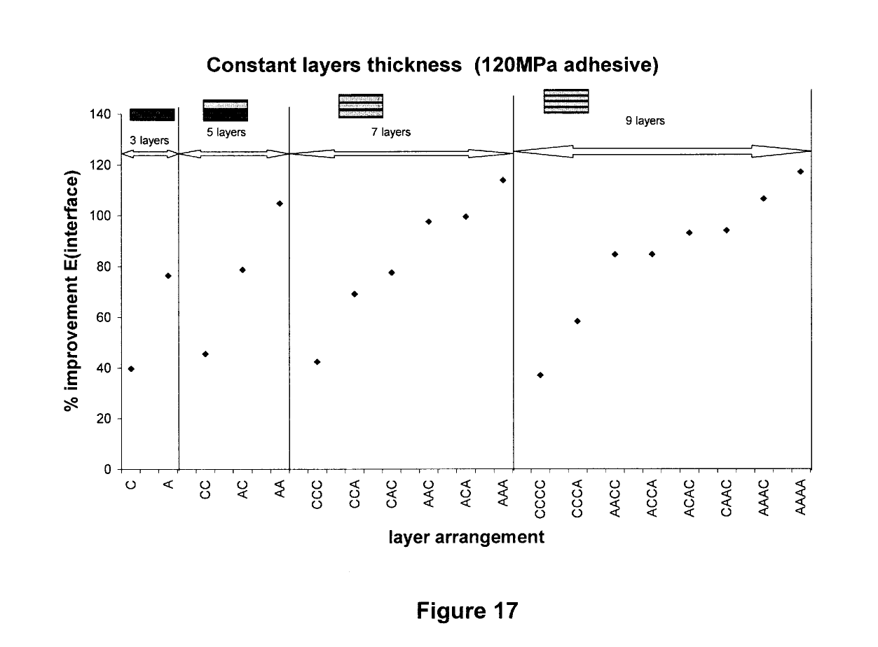

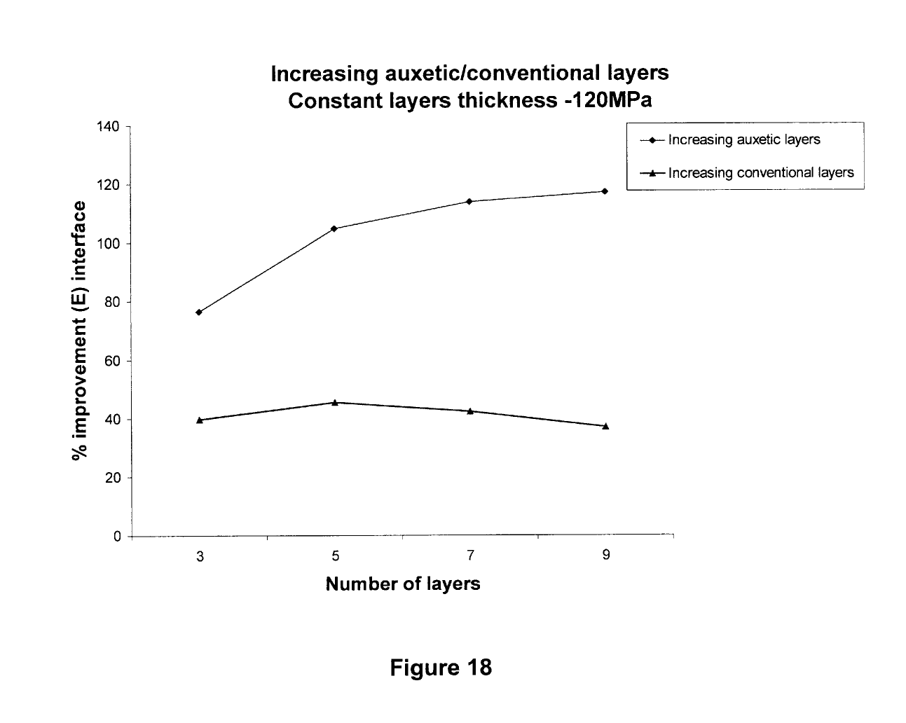

FIG. 17 shows a plot of the improvement in modulus of the structures shown in FIG. 16 for various combinations of auxetic and conventional films. The modulus of the adhesive was 120 MPa. In all cases there is an increase in the modulus. The modulus of the films is higher than of the adhesive and so the films may be making the interface stiffer. It is noted that the improvement shown in this constant layer thickness structure is lower than for the constant interface thickness structures reported above. In the constant interface thickness structures, the proportion of lower modulus adhesive is reduced as the number of layers increases, but in the constant layer-thickness structures this does not occur to the same extent. This difference may account for the reduced improvement. FIG. 18 summarises the results for the all-conventional and all-auxetic structures. The improvement in modulus by the addition of auxetic layers was, in most cases, more than double the improvement due to adding conventional layers. The improvement begins to plateau at 7 and more layers.

As has been explained previously a gradient interface can be produced by varying the properties of the layers through the interface. Such interfaces may allow improved bonding of mismatched surfaces by providing a gradual transition between mismatched mechanical properties.

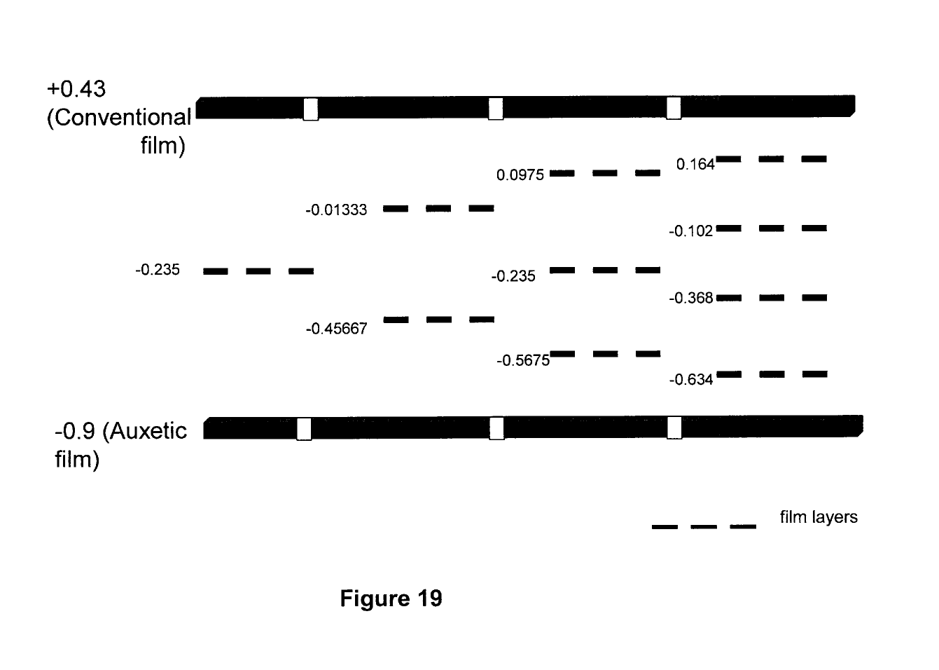

FIG. 19 shows interface structures having 1, 2, 3 and 4 intermediate film layers. All of the film layers have the same modulus, but the Poisson's ratio changes from 0.43 in the uppermost conventional film, to −0.9 in the lowermost auxetic film.

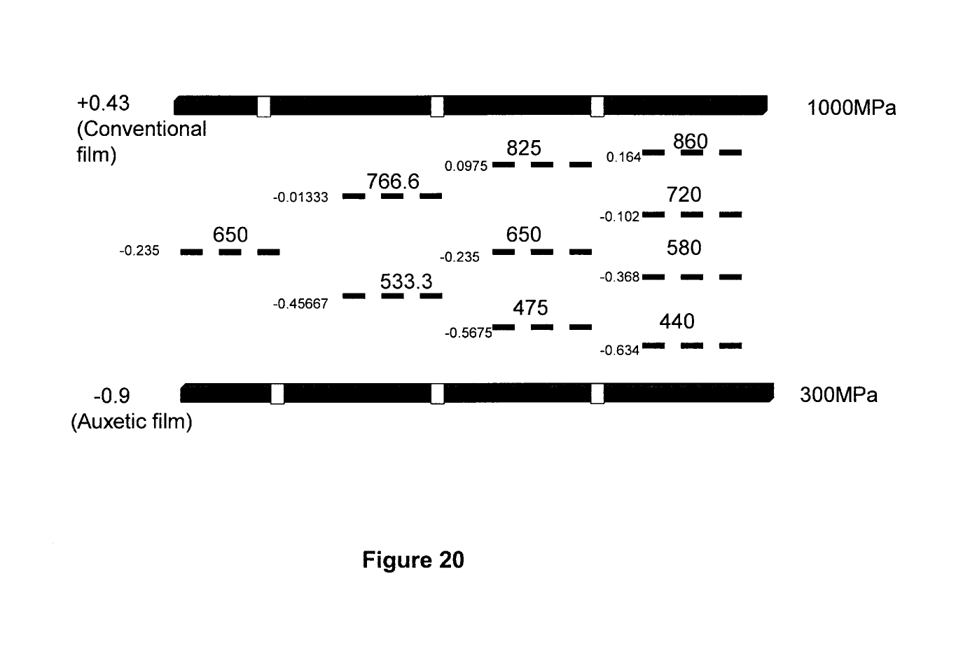

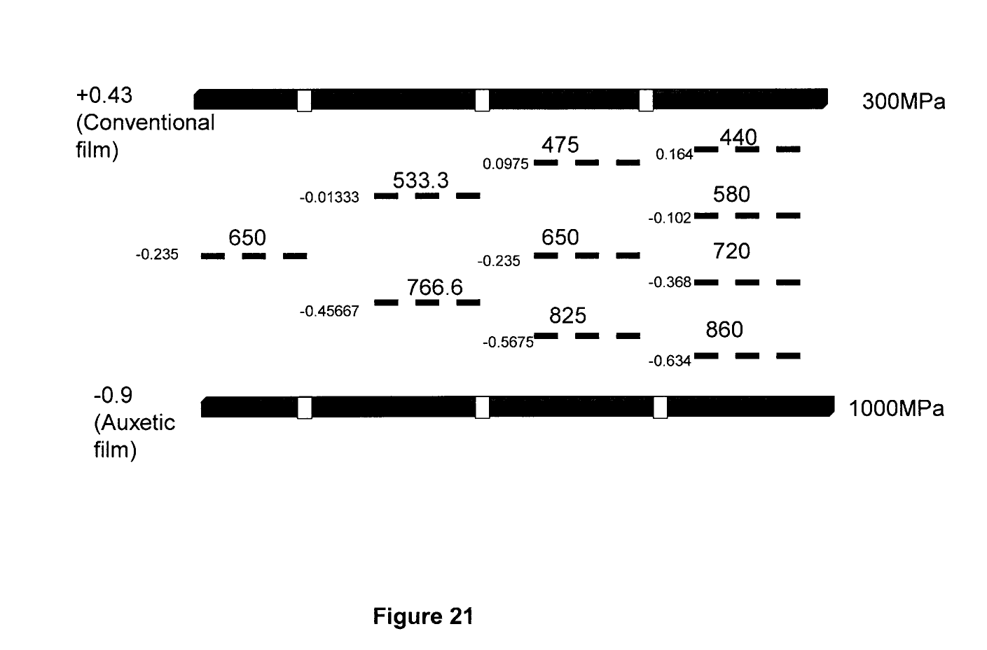

FIG. 20 shows interface structures having 1, 2, 3 and 4 intermediate film layers, moving from a high modulus (1000 MPa) conventional film to a low modulus (300 MPa) auxetic film. FIG. 21 shows interface structures having 1, 2, 3 and 4 intermediate film layers, moving from a low modulus (300 MPa) convention film to a high modulus (1000 MPa) auxetic film.

The numbers to the left of the layers indicate the Poisson's ratio of the layer and the numbers above the layers indicate the modulus of the layer.

To verify the results of the Finite Element analysis, comparable interfaces were modelled using a simple rule-of-mixtures analytical model.

The transverse modulus was given by:—

$${E}_{2} = \frac{{E}_{f} {E}_{m}^{′}}{{V}_{f} {E}_{m}^{′} + {V}_{m} {E}_{f}}$$

E_{f} and V_{f} represent the modulus and volume fraction of the adhesive and Eₘ and Vₘ represent the modulus and volume fraction of the films. Also:—

$${E}_{m}^{′} = \frac{{E}_{m}}{1 - {υ}_{m}^{2}}$$

Where νₘ is the Poisson's ratio of the films. The shear modulus, G₁₂, is given by

$${G}_{12} = \frac{{G}_{f} {G}_{m}}{{V}_{f} {G}_{m} + {V}_{m} {G}_{f}}$$

G_{f} and V_{f} represent the shear modulus and the volume fraction of the adhesive and Gₘ and Vₘ represent the shear modulus of the films.

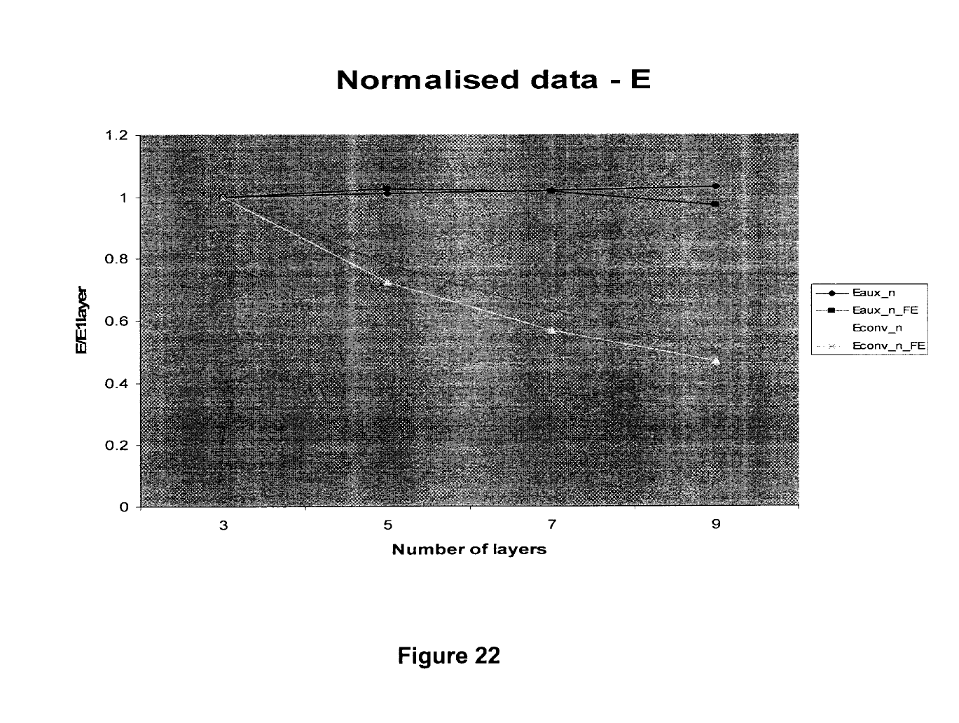

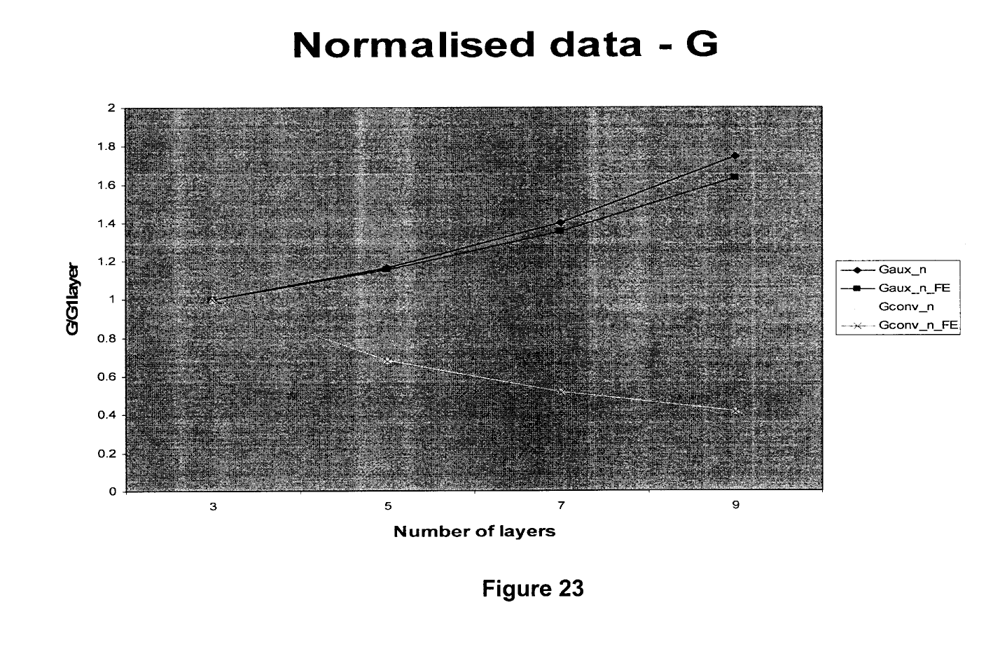

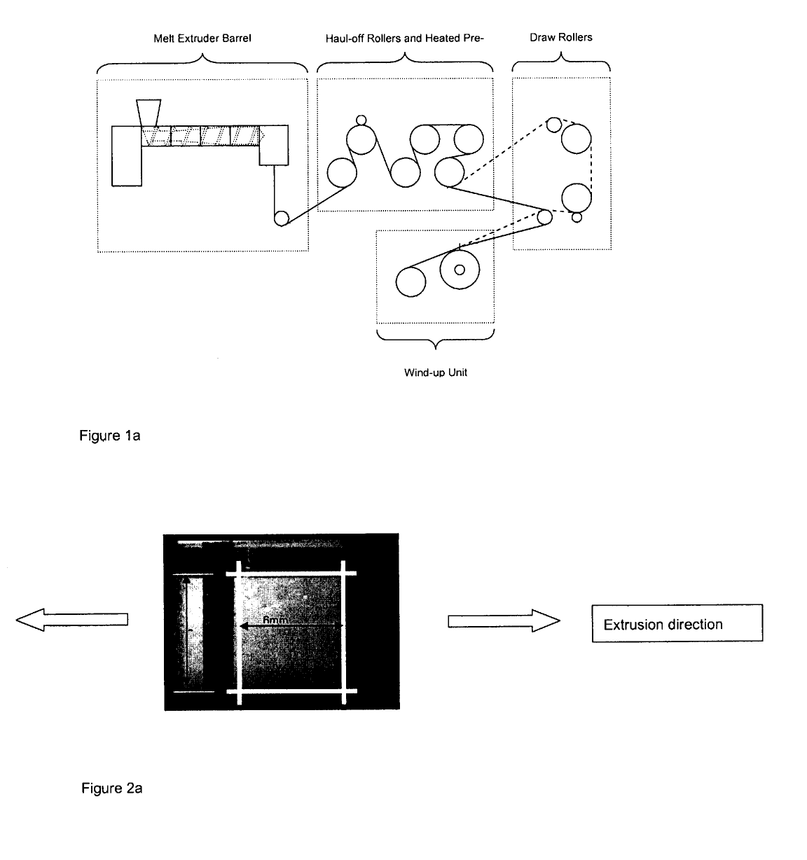

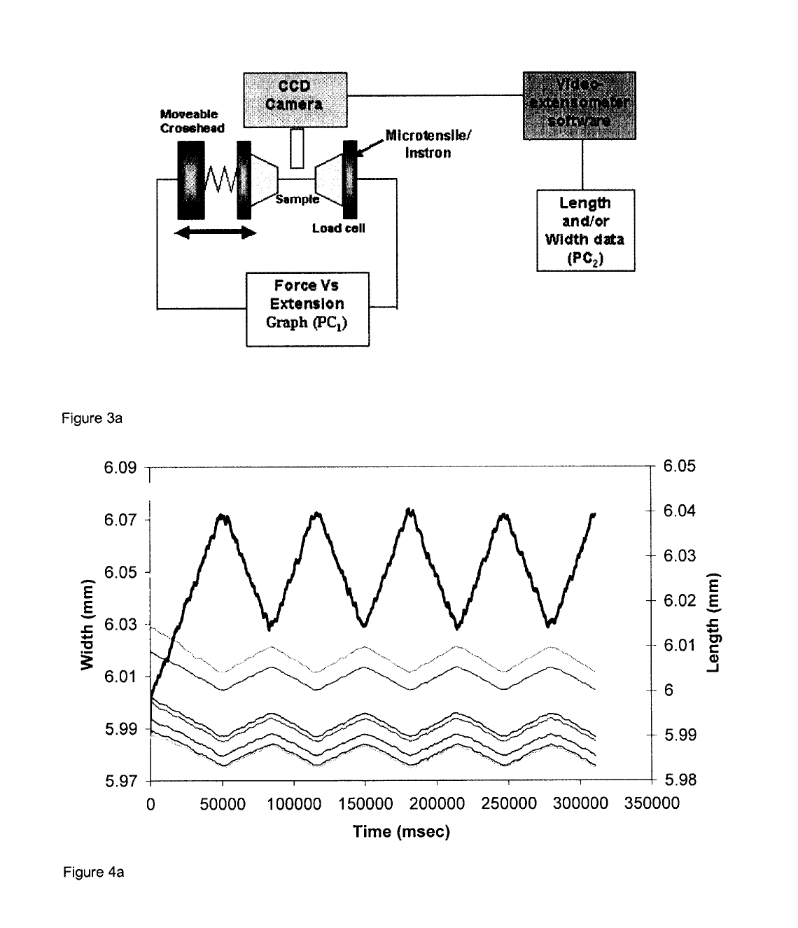

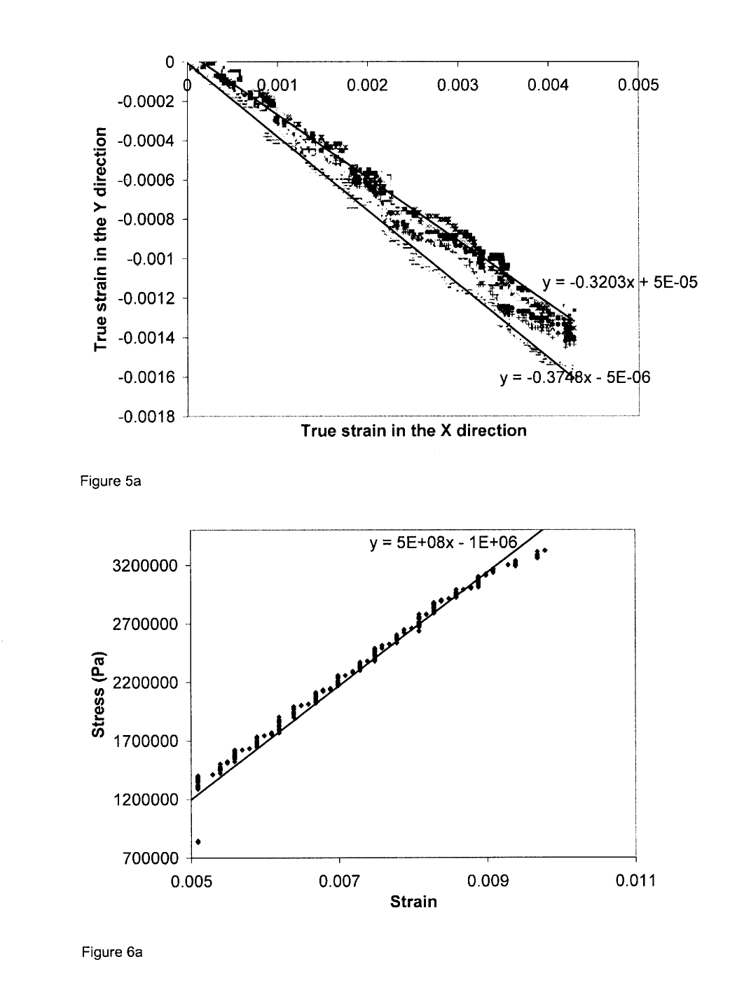

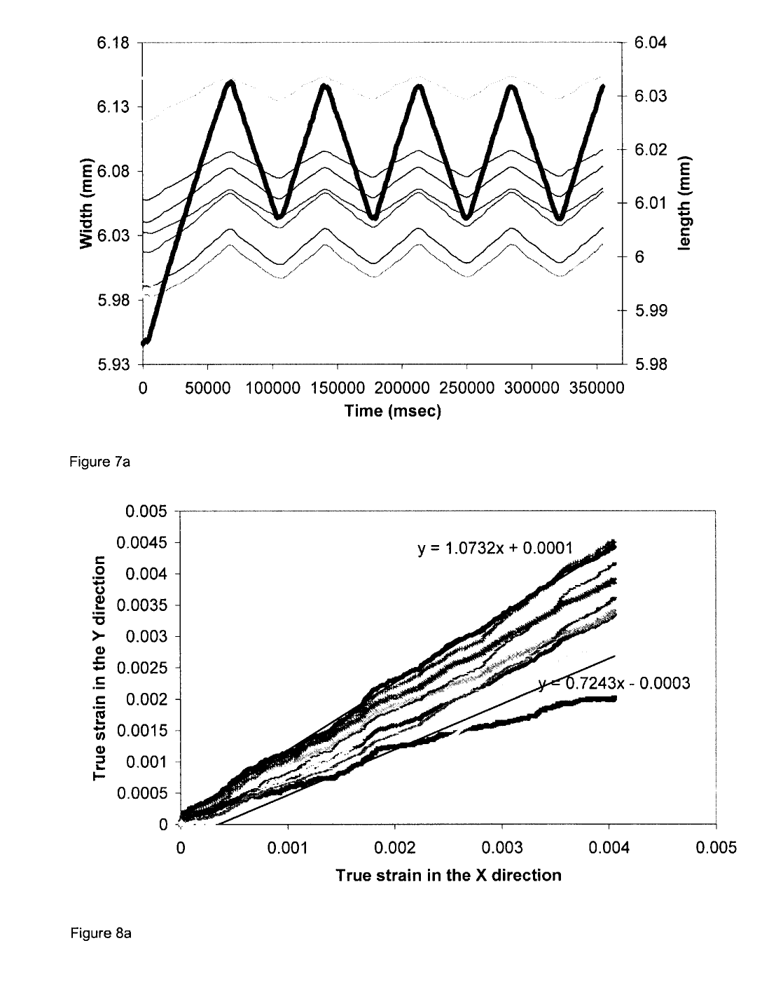

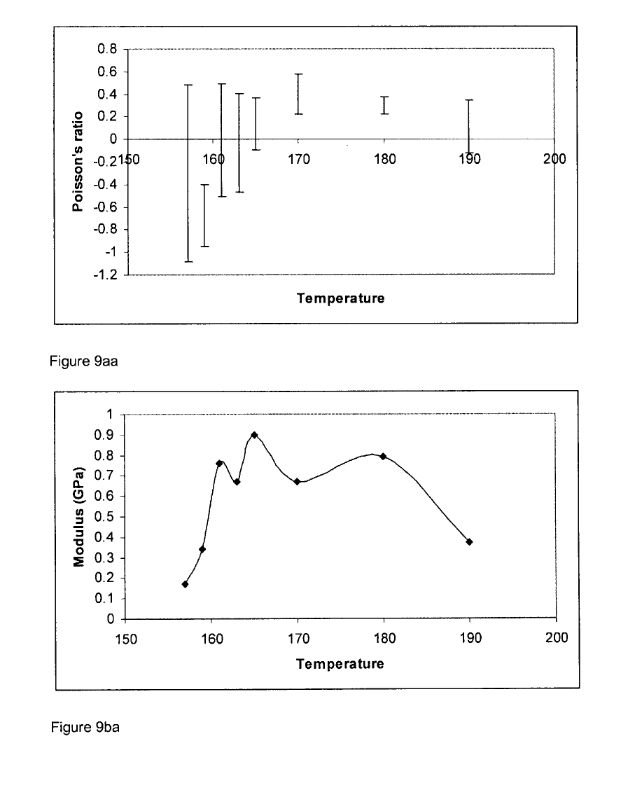

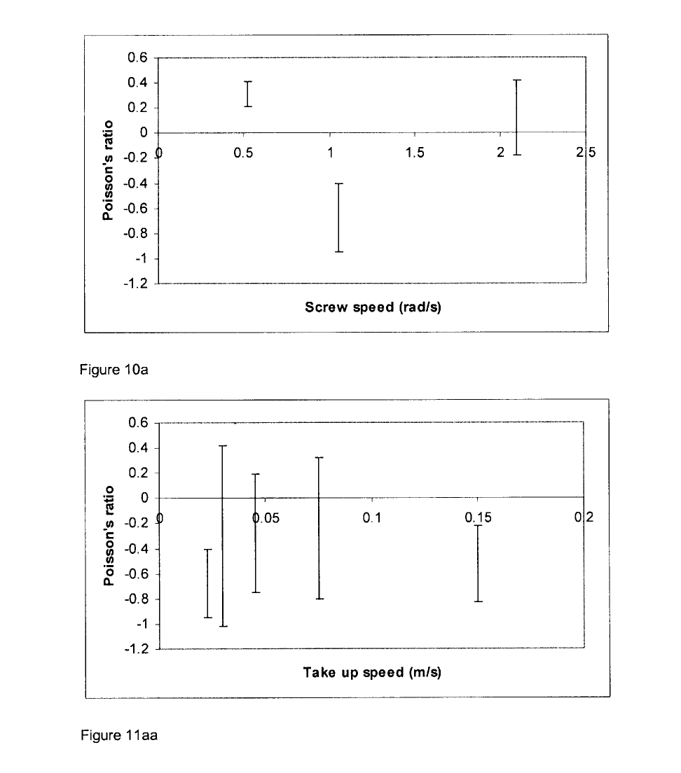

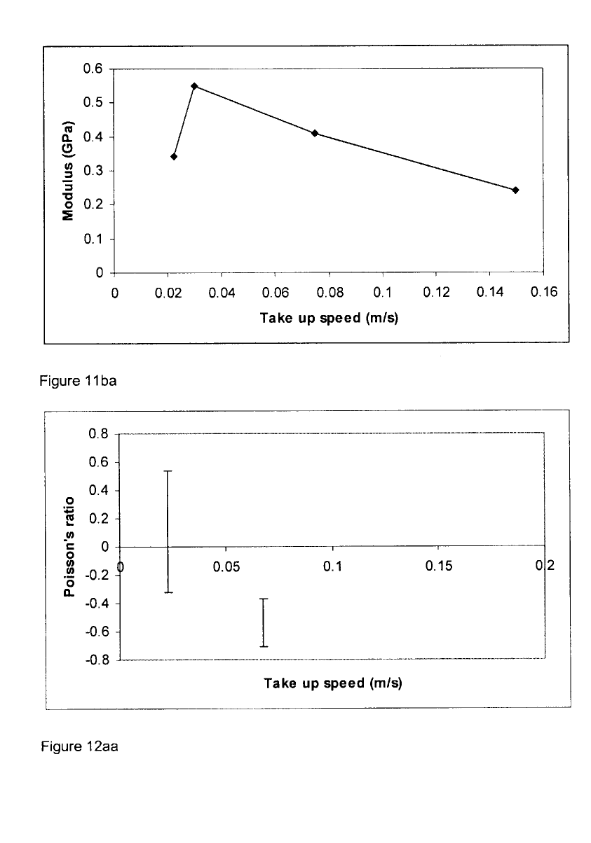

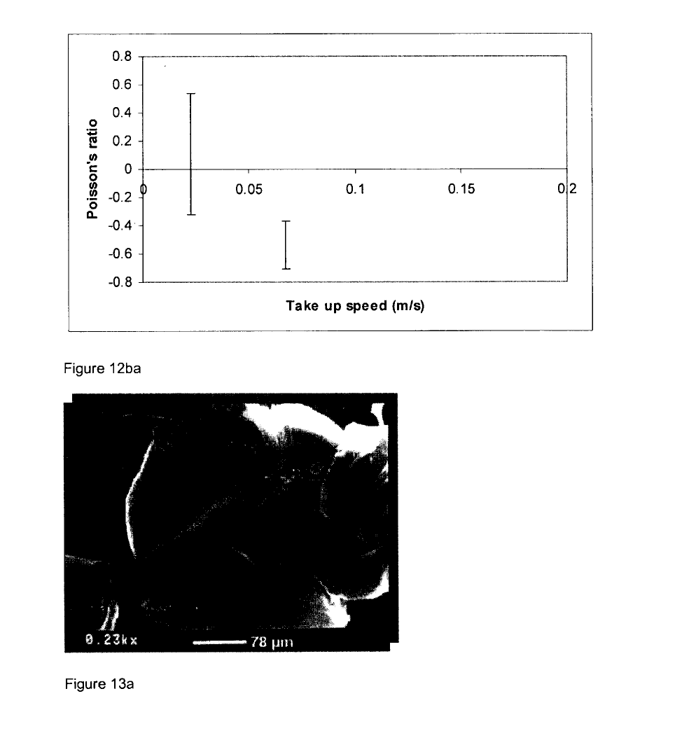

FIGS. 22 and 23 show plots of tensile modulus and shear modulus respectively for the Finite Element and rule of mixtures models described above. These plots show good agreement between the models.

Multi-layer interface utilising conventional and auxetic Polypropylene films have been manufactured. Nine layer interfaces, with the outer layers being film (5 layers of film and 4 layers of adhesive), using all-auxetic, all-conventional and a mix of 2 auxetic and 3 conventional films were produced.

There is therefore provided a multi-layer adhesive and film interface for joining objects. The mechanical properties of the adhesive and films may be selected to provide optimum performance. A number of specific examples have been provided to exhibit structure according to the invention, but as will be appreciated by the skilled reader, a wide variety of interfaces fall within the disclosure of this document. For example, the number of layers may be varied.

The examples described herein have utilised auxetic film layers, but interfaces using auxetic adhesive instead of, or as well as, auxetic film layers also fall within the scope of this disclosure.

The materials of which the interfaces are formed may be selected dependent on the materials being joined and the mechanical properties required of the joint. Examples of possible materials are auxetic Polypropylene, UHMWPE or nylon and epoxies or polyurethanes for the adhesives. In interfaces using a mixture of auxetic and non-auxetic layers, the materials forming those different types of layers may be different, or may be of the same material but processed differently to provide the required behaviour.

It will be understood that the benefits and advantages described above may relate to one embodiment or may relate to several embodiments. It will further be understood that reference to an item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

### APPENDIX 1

The Effect of Processing Parameters on the Fabrication of Auxetic Extruded Polypropylene Films.
G. Chirima, N. Ravirala, A. Rawal, V. R. Simkins, A. Alderson and K. L. Alderson, Centre for Materials Research and Innovation, The University of Bolton, Deane Rd, Bolton, BL3 5AB, UK.

A processing parameter study for extruded polypropylene films has been carried out. Films were extruded at temperatures varying from 157° C. to 230° C., screw speed from 0.525 to 2.10 rad s⁻¹ and take up speed from 0.0225 to 0.15 m s⁻¹. Characterisation of the films was undertaken to determine Poisson's ratio, ν, using video extensometry and it was found that it was possible to vary the Poisson's ratio from positive (ν=+0.4) to negative (as low as ν=−1) by varying the processing parameters, allowing the possibility of tailoring the Poisson's ratio to specified applications driven values.

### INTRODUCTION

Auxetic materials exhibit a negative Poisson's ratio, ν, [1,2]. Most auxetic materials have a microstructure that induces a negative Poisson's ratio at the macroscale. Examples of such materials are polymeric and metallic foams [1,3-7] and microporous polymers. Caddock and Evans [8] discovered that expanded microporous polytetraflouroethylene (PTFE) was auxetic due to a particular microstructure rather than it being an intrinsic property of PTFE itself. The microstructure consisted of an array of nodules interconnected by fibrils [8,9]. Evans and Alderson [10-13] further developed cylinders of ultra high molecular weight polyethylene (UHMWPE) with a similar nodule-fibril microstructure and it was found to be auxetic with a strain dependent negative Poisson's ratio as low as −6. The processing route involved the compaction, sintering and extrusion of polymer powder. Further work [14,15] produced cylinders of nylon and polypropylene (PP).

In 2002, auxetic polypropylene fibres were successfully produced [16] from specially adapted melt extrusion techniques. The fibres were extruded at unusual processing conditions, i.e. an extrusion temperature of 159° C., screw speed of 1.05 rad s⁻¹ and a take-up speed of 0.03 ms⁻¹. A recently published study of the processing parameters for the fibres [17] revealed that the key processing parameter was the processing temperature. The screw speed and take-up speed produced variations in the level of auxeticity and modulus, allowing the possibility of tailoring the fibre properties. By changing the extruder die to a slit orifice of dimensions 63.5×14.2×0.38 mm, auxetic polypropylene films [18] have been developed. Initial work focussed on using the same processing window as has been successfully used for the production of auxetic PP fibres, with slight variations around the key parameters (i.e. temperatures between 158 and 162° C., screw speeds between 0.525 and 1.575 rads⁻¹ and take-up speeds between 0.015 and 0.06 m s⁻¹). In addition, processing the polypropylene powder at 230° C. was reported to produce no auxetic behaviour in the films. However, it is not clear what will happen to the auxeticity and other mechanical properties at temperatures between 162 and 230° C. (and, indeed, at lower temperatures) as the other processing parameters are varied. This paper reports on a parametric study for the production of auxetic PP films. The effect of varying important processing parameters of temperature, take up speed and screw speed on the auxetic behaviour and Young's Modulus of films was observed. Characterisation was carried out using video extensometry in conjunction with microtensile testing and a range of Poisson's ratio values from ν=+0.4 to ν=−1 was obtained simply by varying the processing parameters. This study, thus, provides the means for the production of films with tailored mechanical properties.

### EXPERIMENTAL

### Extrusion of Polypropylene Powder

Polypropylene films were produced via a specially adapted melt extrusion process with polypropylene in powder form as the precursor. The PP powder used was Coathylene PB0580, supplied by Univar plc, which is the same powder used in previously successful production of auxetic PP fibres [16,17] and cylinders [14]. A schematic of the extruder used is shown in FIG. 1a. The extruder has five temperature zones which can be independently set. The powder is transferred to the die zone area by a single screw. If a constant feed is maintained, powder will be forced to move forward to the die which, for film production, has a slit opening of dimensions 63.5×14.2×0.38 mm. As the film emerges, it is directed to take up rollers, and then collected. The parameters used for the production of films in this study are as shown in Table 1. The parameters were chosen to provide an indication of the effects of varying the temperature, screw speed and take up speed whilst keeping other parameters constant. For temperature variations, the screw speed was 1.05 rad⁻¹, the take up speed 0.0225 ms⁻¹ and the temperature itself varied from 157° C. to 190° C. For screw speed variations, the temperature was held at 159° C., the take up speed 0.0225 ms⁻¹ and the screw speed itself varied from 0.525 rads⁻¹ to 2.1 rads⁻¹. For take up speed, two temperatures were considered. Firstly, the temperature was held at 159° C., the screw speed was 1.05 rad s⁻¹ and the take up speed varied from 0.0225 ms⁻¹ to 0.15 ms⁻¹. The second temperature used was 180° C., the screw speed was 2.1 rad s⁻¹ and the take up speed varied from 0.0225 ms⁻¹ to 0.0675 ms⁻¹. In addition, for comparison purposes with previous work, a batch of films were produced at a processing temperature of 230° C., screw speed of 1.05 rad s⁻¹ and take up speed of 0.03 m s⁻¹.

### Characterisation of Polypropylene Films

Films were tested in the extrusion direction as illustrated in FIG. 2a. A Deben Microtensile testing stage (Microtest) was used together with a MESSPHYSIK ME 46 videoextensometer [19] to determine the Poisson's ratio and Young's Modulus of the films. The Deben Microtest instrument allows for a range of materials to be deformed to loads up to 300N. The gauge length can be varied between 10 mm and 20 mm and the markers on the samples here describe a box of dimensions 6×6 mm (see FIG. 2a). In this investigation a strain rate of 0.1 mm min⁻¹ was maintained for the film characterization. Cyclic tests using travel limits maintained between 0.5% and 1% strain levels were performed, thus strains were within the elastic region predetermined by previous work [18] and confirmed in this study. Force-time data were obtained.

The videoextensometer is a commercially available software package developed by Messphysik GmbH [19] that measures strains and/or extensions. In the present work, videoextensometry was used to measure the strains in both axial and transverse directions, and hence the Poisson's ratio of films can be determined.

The videoextensometer operates directly as a non-contact strain measuring system by determining the relative distance between two marked targets caused by deformation of the specimen. The videoextensometry software works with a special measurement algorithm based on the evaluation of the black and white contrast between the specimen surface and the targets. The greater the contrast, the more consistent are the results.

The camera was rigidly mounted to a tripod (see FIG. 3a) and was positioned such that there was no obstruction between lens and specimen during the test. During the tensile test, no movement of the sample relative to the camera lens was ensured since such movements can lead to incorrect measurement of length.

It is essential to ensure adequate, even and constant intensified illumination of the sample to enable the changes in contrast to accurately define targets and sample edges. Hence the videoextensometry was performed in a black box with a lamp as a light source in order to provide the constant lighting conditions. Camera lenses were sharply focused and the diaphragm was adjusted to produce the required lighting conditions. This set up ensured that there were no disturbances in lighting conditions. Transverse width data were collected for 10 sections along the length of the film, enabling the individual width section data to be generated as well as an average width data set.

### Data Analysis

FIG. 4a shows the variation of length and width on application of strain for a film produced at a temperature of 230° C., screw speed of 1.05 rads⁻¹ and a take-up speed of 0.03 ms⁻¹. From this videoextensometry graph, it can be seen that as length is increasing, width is decreasing, which is a characteristic of a conventional material. It is clear that the variations of length and width are repeatable, hence the true strain was determined by using the third cycle of the graph, which is the usual approach adopted for analysing auxetic fibres and films [16-18]. The true strains along the x and y directions are given by:

$${ɛ}_{x} = ln ( \frac{l}{{l}_{0}} ) \qquad ( 1 )$$

where I₀ is the original length and/is the deformed length of the film.
and

$${ɛ}_{y} = ln ( \frac{w}{{w}_{0}} ) \qquad ( 2 )$$

where wₒ is the original width and w is the deformed width of the film.

By plotting the true strain in the y direction against the true strain in the x direction, the Poisson's ratio, v_{xy} can be calculated since:

$${v}_{xy} = - \frac{d {ɛ}_{y}}{d {ɛ}_{x}} \qquad ( 3 )$$

FIG. 5a shows the graph constructed for the film produced at a temperature of 230° C., screw speed of 1.05 rads⁻¹ and a take-up speed of 0.03 ms⁻¹. The Poisson's ratio in this case is v=+0.32.

Data from the micro-tensile machine were used to determine the Young's modulus, (FIG. 6a). The gradient of the stress versus strain graph produced gives the value of the Young's modulus as shown in FIG. 6a, with a value of E=0.5 GPa.

The same approach can be used to obtain the Poisson's ratio and modulus along the extrusion direction for the other films produced in this study. As a further example, films produced at a temperature of 159° C., a screw speed of 1.05 rads⁻¹ and a take-up speed of 0.03 ms⁻¹ are also considered here. The graph in FIG. 7a shows that the curves for width and length are in phase throughout all regions, indicating that this film is auxetic, having the width increase as the length increases. FIG. 8a shows the true transverse strain/true longitudinal strain plot constructed from the third cycle of FIG. 7a. From this, it can be seen that the Poisson's ratio for a film extruded at a temperature of 159° C., screw speed of 1.05 rads⁻¹ and take-up speed of 0.03 m s⁻¹ ranges from v=−1.07 to v=−0.72.

### Results

### Effect of Varying the Temperature

Table 2 shows the effect of varying the temperature on the range of Poisson's ratio and modulus values obtained. The screw speed was held at 1.05 rads⁻¹ and the take-up speed at 0.0225 ms⁻¹. The results are plotted as FIG. 9aa (for the Poisson's ratio) and b (for the modulus). For the Poisson's ratio graph, in all cases, it is the range of values obtained that is plotted, as this is the usual approach to presenting data for auxetic polymers (see, for example, [17,18]). FIG. 9aa shows that processing at 159° C. produced 100% auxetic films and at 170° C. and 180° C., the films were 100% conventional. However, at the other processing temperatures, behaviour is seen to be a combination of auxetic and conventional. The largest negative value, ν=−1.08, was seen at a temperature of 157° C., which is below the usual 159° C. processing temperature. It should be noted, though, that auxetic character here is only observed in 1 of the 10 samples tested. The remaining 9 samples were conventional. Auxetic character is also observed at 161, 163 and 165° C. and, more surprisingly, at 190° C., with values of Poisson's ratio ranging from ν=−0.12 to ν=+0.35. In this case, what could be termed mixed behaviour is seen, whereby all the films produced (rather like previous work on the fibres [17]) show regions of auxetic and conventional behaviour. At 190° C., 18% of each of the samples tested are auxetic. The production of auxetic films at 190° C. is significant as this is the first time that auxetic character has been seen at such a high temperature, i.e. 29° C. above the peak melting temperature of 161° C., as defined by differential scanning calorimetry (DSC) [18].

FIG. 9ba shows the variation of modulus with processing temperature and it is interesting to note that the modulus is lowest at 157° C., rising to a plateau level at 161° C. until 190° C. where the modulus falls back to a value close to that of the 159° C. samples (i.e. 0.37 GPa as compared to 0.34 GPa).

### Effect of Varying the Screw Speed

Table 3 shows the effect of varying the screw speed on the range of Poisson's ratio and modulus values obtained. The temperature was held at 159° C. and the take up speed at 0.0225 ms⁻¹. The data are plotted in FIG. 10a for the Poisson's ratio. The modulus results are not given in the Table for 0.525 rads⁻¹ and 2.1 rads⁻¹ as in these cases, the measured values were outside of the accepted tolerance i.e. were very scattered. The films produced at 0.525 rads⁻¹ are completely conventional. As the extruder speeds up to 1.05 rads⁻¹, the films become completely auxetic. The highest screw speed investigated here (2.1 rads⁻¹) also shows some auxetic character, with 3 of the 9 films being auxetic and values as low as ν=−0.18.

### Effect of Varying the Take Up Speed

Tables 4a and 4b show the effect of varying the take up speed on the Poisson's ratio and modulus values. In Table 4a, the temperature was held at 159° C. and the screw speed at 1.05 rads⁻¹. The data from this table are presented in FIGS. 11aa and ba. It is interesting to see that some degree of auxetic character from 30-100% is always seen as the take up speed is varied. The results in Table 4b and presented in FIGS. 12aa and ba are of much greater potential significance. The temperature of 180° C. at a screw speed of 1.05 rads⁻¹ did not show any auxetic character (see Table 2). However, by running the extruder at 2.1 rads⁻¹ and varying the take up speed, auxetic character can be obtained. Indeed, at a take up speed of 0.0675 ms⁻¹, the films produced are completely auxetic.

### DISCUSSION

This study has shown that it is possible to produce films with very different Poisson's ratio and modulus combinations simply by varying the processing parameters. The most interesting findings here concern temperatures above the 161° C. peak melting temperature as determined by DSC [18]. In order to understand why this could be the case, it is necessary to look closely at what is happening during the extrusion process. In particular, it is interesting to study the effect of temperature in combination with screw speed. It is believed that the films have a negative Poisson's ratio because of their microstructure, in common with other auxetic polymers [8-18]. However, unlike polymers produced as cylinders, the extruded films (and also the fibres) are thought to be auxetic not with a microporous nodule-fibril structure, but rather a reduced porosity fused particle structure [16-18]. This is believed to form by the surface melting of the powder particles leading to the structure shown in FIG. 13a, which is a section through an auxetic PP fibre. The micrograph shows the individual powder particles are still distinct, which would suggest that the particles are not fully molten. The fibre shown in the micrograph was processed at 159° C., below the peak melting temperature. It is necessary to now investigate if the particles are fully molten by the peak melting temperature or if the negative Poisson's ratio effect seen at higher temperatures here can be attributed to surface particle melting. As a first approximation, the process could be likened to a sphere undergoing melting. Then, the change in particle radius with time can be calculated from [20]:

$$\frac{d {R}_{θ}}{d t} = \frac{- {h}_{θ} ( {T}_{b} - {T}_{o} )}{{ρ}_{s} Δ H} \qquad ( 4 )$$

where R_{θ} is the local radius of the particle, t is the dwell time in the extruder, h_{θ} is the local heat transfer coefficient (in this case 24.5 W/m²K), T_{b} is the bulk temperature (i.e. the set temperature of the extruder), Tₒ is the melting temperature, ρₛ is the density (in this case, 905 kg m⁻³) and ΔH, the latent heat (in this case, 133696.7 J kg⁻¹). Integrating equation (4) with respect to time gives an equation for the decrease in local radius, which is effectively the amount of radius melting in the particle, such that:

$${R}_{θ} = \frac{- {h}_{θ} ( {T}_{b} - {T}_{o} ) t}{{ρ}_{s} Δ H} \qquad ( 5 )$$

The average dwell time for the particles in the extruder [21] is given by:

$$t = \frac{2 {HD}_{s}}{{ND}_{d} {δ}_{f}} \qquad ( 6 )$$

where δ_{f} is the flight clearance of the screw (in this case 0.02 mm), H is the channel depth (in this case 2.5 mm), Dₛ is the screw diameter (in this case 25.4 mm), D_{b} is the inside diameter of the barrel and is given by Dₛ+2δ_{f}, so in this case is equal to 25.44 mm and N is the number of rotations of the screw. N was allowed to vary from 1 to 30 revolutions per minute and the dwell times associated with these values are given in Table 5. The average powder particle size used in this work was previously measured at 52±13 μm diameter. So, once the local radius calculated has exceeded 19.5 to 32.5 μm, the powder is fully molten. Very simple manipulation of equations (4-6) using the variables examined here reveals that, for a temperature difference (T_{b}−Tₒ) of just 2° C., complete melting of the PP powder will occur, i.e. the temperature window for processing is very tightly defined, explaining why in FIG. 9a*, there is a very small temperature range for producing 100% auxetic films, with conventional behaviour seen to some degree just 2° C. above or below 159° C. It should be noted here, though, that the equations examined are very much a first approximation. The melting point of this PP powder is not as sharp as is assumed, with the DSC trace [18] indicating a 20-30° C. range of temperature from the onset of melting to the peak melting temperature of 161° C. Also, it is acknowledged that there will be a temperature gradient likely to occur within the extruder, explaining possibly why there is auxetic character obtained between 157 and 165° C.

Interestingly, at processing temperatures of 190° C. (screw speed 1.05 rads⁻¹ and take up speed 0.0225 ms⁻¹) and 185° C. (screw speed 2.10 rads⁻¹ and take up speeds 0.0225 and 0.0675 ms⁻¹), well above the onset of melting and indeed the peak melting temperature, auxetic behaviour is also obtained. It is possible that the auxetic behaviour in these cases is due to random molecular chain arrangements of the softened molten material, i.e. a different mechanism is occurring.

The simple, basic model presented here does not provide any insight into the effect of varying the take up speed. However, it is interesting to note that changing this parameter (see Tables 4a and 4b) still results in auxetic character in the films as it did when this variable was considered for the auxetic fibres [17]. There, it was concluded that increasing the take up speed led to slight drawing of the fibres whilst still retaining their microstructure and this appears to be the case here. The most striking of all the findings is that 100% auxeticity was seen at a take up speed of 0.15 m s⁻¹ for processing at 159° C. The idea that increasing the take up speed increases the auxeticity is borne out by the findings shown in Table 4b, where again 100% auxeticity is found at the higher take up speed examined for processing at 180° C. Thus, for the films, some aligning of the microstructure appears desirable.

It should be noted that these results also indicate that the process examined here is complex. What can be concluded from this study is that the mechanical properties, in particular the Poisson's ratio, can be varied dramatically by slight variations in the processing parameters.

### CONCLUSIONS

PP films can be extruded to have a range of Poisson's ratio and modulus values by varying the key processing parameters of extruder temperature, screw speed and take up speed. It was found that auxetic behaviour was observed for the first time for PP at temperatures well above the 159° C. acknowledged processing temperature [14, 16-18], i.e. at 165° C. and more importantly at 180 and 190° C. when the other processing parameters are varied. This indicates that a more complex interplay between the processing temperature, screw speed and take-up speed exists for the films than was previously believed. Nevertheless, producing a range of Poisson's ratios and modulus values by slight variations in processing parameters allows for the production of films with specific, applications driven properties.

### REFERENCES

1. R. S. Lakes, Science, 235, 1038 (1987).
2. K. E. Evans, M. A. Nkansah, I. J. Hutchinson and S. C. Rogers, Nature, 353, 124 (1991).
3. E. A. Friis, R. S. Lakes and J. B. Park, J. Mater. Sci., 23, 4406 (1980).
4. J. B. Choi and R. S. Lakes, J. Mater. Sci., 27, 5375 (1992).
5. J. B. Choi and R. S. Lakes, J. Compos. Mater, 29, 113 (1995).
6. N. Chan and K. E. Evans, J. Mater. Sci., 32, 5725 (1997).
7. K. E. Evans, Chem. Ind. 20, 654 (1990).
8. B. D. Caddock and K. E. Evans.; J. Phys. D: Appl. Phys., 22, 1877 (1989).
9. K. E. Evans, Endeavour, 15, 170 (1991).
10. K. L. Alderson and K. E. Evans, Polymer., 33, 4435 (1992).
11. A. P. Pickles, R. S. Webber, K. L. Alderson; P. J. Neale and K. E. Evans; J. Mater. Sci., 30, 4059 (1995).
12. K. L. Alderson, A. P. Kettle, P. J. Neal, A. P. Pickles and K. E. Evans; J. Mater. Sci., 30, 4069 (1995).
13. P. J. Neale, A. P. Pickles, K. L. Alderson and K. E. Evans; J. Mater. Sci., 30, 4087 (1995).
14. A. P. Pickles, K. L. Alderson and K. E. Evans; Poly. Eng. and Sci., 36(5), 636, (1996).
15. K. L. Alderson, A. Alderson, R. S. Webber and K. E. Evans, J. Mater. Sci Lett., 17, 14015 (1998).
16. K. L. Alderson, A. Alderson, G. Smart, V. R. Simkins and P. J. Davies; Plastics Rubber and Composites., 31, 344 (2002).
17. K. L. Alderson, A. Alderson, P. J. Davies, G. Smart, N Ravirala and V. R. Simkins, J. Mater. Sci., 42, 7991 (2007).
18. N. Ravirala; A. Alderson; K. L. Alderson and P. J. Davies, Poly. Eng. Sci., 45, 517 (2005).
19. Messphysik videoextensometer package, Messphysik, Laborgerrite Ges, M. B. H., Furstenfeill, Austria.
20. O. J. Ilegbusi, M. Iquchi and W. E. Wahnsiedler, “Mathematical and Physical Modelling of Materials Processing Operations”, Chapman and Hall/CRC, Florida, US, 2000.
21. Z. Tadmor and C. G. Gogos, “Principles of Polymer Processing”, Wiley and Sons, New Jersey, US, 2006.

### Tables for Appendix 1

TABLE 1
Parameters used to produce different types of films.

| Temperature (° C.) | Screw Speed (rads⁻¹) | Take up speed (m s⁻¹) |
|---|---|---|
| 157 | 1.05 | 0.0225 |
| 159 | 0.525 | 0.0225 |
| 159 | 1.05 | 0.0225 |
| 159 | 2.10 | 0.0225 |
| 159 | 1.05 | 0.045 |
| 159 | 1.05 | 0.075 |
| 159 | 1.05 | 0.15 |
| 161 | 1.05 | 0.0225 |
| 163 | 1.05 | 0.0225 |
| 165 | 1.05 | 0.0225 |
| 170 | 1.05 | 0.0225 |
| 180 | 1.05 | 0.0225 |
| 180 | 2.10 | 0.0225 |
| 180 | 2.10 | 0.0675 |
| 190 | 1.05 | 0.0225 |
| 230 | 1.05 | 0.03 |

TABLE 2
Effect of varying the temperature on the range
of Poisson's ratio and modulus values.

| Extrusion temperature | Range of Poisson's | Modulus | Auxeticity |
|---|---|---|---|
| (° C.) | ratio values | (GPa) | (%) |
| 157 | −1.08 to +0.48 | 0.17 | 10 |
| 159 | −0.95 to −0.40 | 0.34 | 100 |
| 161 | −0.51 to +0.49 | 0.76 | 25 |
| 163 | −0.47 to +0.41 | 0.67 | 33 |
| 165 | −0.09 to +0.37 | 0.90 | 14 |
| 170 | +0.22 to +0.58 | 0.67 | 0 |
| 180 | +0.22 to +0.38 | 0.79 | 0 |
| 190 | −0.12 to +0.35 | 0.37 | 18 |

The screw speed in all cases is 1.05 rads⁻¹ and the take-up speed is 0.0225 m s⁻¹.

TABLE 3
Effect of varying the screw speed on the range
of Poisson's ratio and modulus values.

| Screw speed | Range of Poisson's | Modulus | Auxeticity |
|---|---|---|---|
| (rad s⁻¹) | ratio values | (GPa) | (%) |
| 0.525 | +0.21 to +0.41 | — | 0 |
| 1.05 | −0.95 to −0.40 | 0.34 | 100 |
| 2.10 | −0.18 to +0.42 | — | 33 |

The temperature in all cases is 159° C. and the take-up speed is 0.0225 m s⁻¹.

TABLE 4a
Effect of varying the take up speed on the
range of Poisson's ratio and modulus values.

| Take up speed | Range of Poisson's | Modulus | Auxeticity |
|---|---|---|---|
| (m s⁻¹) | ratio values | (GPa) | (%) |
| 0.0225 | −0.4 to −0.95 | 0.34 | 100 |
| 0.03 | −1.02 to +0.42 | 0.55 | 50 |
| 0.045 | −0.75 to +0.19 | — | 63 |
| 0.075 | −0.8 to +0.32 | 0.41 | 50 |
| 0.15 | −0.83 to −0.22 | 0.24 | 100 |

The temperature in all cases is 159° C. and the screw speed is 1.05 rad s⁻¹.

TABLE 4b
Effect of varying the take up speed on the
range of Poisson's ratio and modulus values.

| Take up speed | Range of Poisson's | Modulus | Auxeticity |
|---|---|---|---|
| (m s⁻¹) | ratio values | (GPa) | (%) |
| 0.0225 | −0.32 to +0.54 | 0.36 | 20 |
| 0.0675 | −0.37 to −0.71 | 0.33 | 100 |

The temperature in all cases is 180° C. and the screw speed is 2.10 rad s⁻¹.

TABLE 5
Variation of dwell time, t, as the number
of rotations of the screw are varied.

| Screw speed | N, Number of rotations of the | Dwell time |
|---|---|---|
| (rad s⁻¹) | screw (revs min⁻¹) | (s) |
| 0.105 | 1 | 15000 |
| 0.525 | 5 | 3000 |
| 1.05 | 10 | 1500 |
| 1.575 | 15 | 996 |
| 2.10 | 20 | 750 |
| 2.625 | 25 | 600 |
| 3.15 | 30 | 480 |

1. A multi-layer adhesive interface, comprising
at least one film layer and at least one adhesive layer,
each adhesive layer being adhered to at least one film layer,
the film layers being impermeable to the adhesive of the adhesive layers, wherein at least one of the adhesive or film layers has a negative Poisson's ratio.

2. An interface as claimed in claim 1, wherein at least one of the film layers has a negative Poisson's ratio.

3. An interface as claimed in claim 1, wherein at least one of the adhesive layers has a negative Poisson's ratio.

4. An interface as claimed in claim 1, wherein the Poisson's ratio of the layers varies through the interface.

5. An interface as claimed in claim 1, wherein the Poisson's ratio of the film layers varies through the interface.

6. An interface as claimed in claim 1, wherein the Poisson's ratio of the adhesive layers varies through the interface.

7. An interface as claimed in claim 1, wherein the Poisson's ratio of the film layers varies from a negative value for one outermost film layer to a positive value for the other outermost film layer.

8. An interface as claimed in claim 1, wherein the Poisson's ratio of the adhesive layers varies from a negative value for one outermost adhesive layer to a positive value for the other outermost adhesive layer.

9. An interface as claimed in claim 1 wherein the outermost layer on one surface is an adhesive layer.

10. An interface as claimed in claim 1 wherein the outermost layer on one surface is a film layer.

11. An interface as claimed in claim 1 wherein the Young's modulus of the film layers is higher than the Young's modulus of the adhesive layers.

12. An interface as claimed in claim 1 wherein the Young's modulus of the film layers is lower than the Young's modulus of the adhesive layers.

13. An interface as claimed in claim 1 wherein one or more film layers has a Young's modulus greater than the Young's modulus of one or more of the adhesive layers, and one or more other film layers has a Young's modulus which is lower than the than the Young's modulus of one or more of the adhesive layers.
